(19) United States
(12) Patent Application Publication
(10) Pub. No.: US 2016/0302617 A1
(43) Pub. Date: Oct. 20, 2016

(54) Grill Installation Kit

(71) Applicant: Grit Rogge, Hannover (DE)

(72) Inventor: Dirk ROGGE, Hannover (DE)

(21) Appl. No.: 15/055,715

(22) Filed: Feb. 29, 2016

(30) Foreign Application Priority Data
Apr. 14, 2015 (DE) 20 2015 002 652

(51) Int. Cl. A47J 37/07; F24B 1/193; F24B 1/182

(52) U.S. Cl. CPC A47J 37/0763; F24B 1/182; F24B 1/193

(57) ABSTRACT

The invention relates to a grill installation kit for a table, comprising
a bowl having openings in each sidewall and at the bottom,
an ash trap which extends essentially in a plane and can be arranged on the bottom of the bowl spaced by at least one spacer and essentially in parallel to the bottom of the bowl,
a firing tray having openings, which firing tray can be arranged on the ash trap spaced by at least one spacer and essentially in parallel to the ash trap, and
a grillage (5).

The present invention relates to a grill installation kit which can be easily incorporated into a table, e.g. a garden table, especially a wooden table or a plastic table.

### STATE OF THE ART

Tables having an integrated grill are already known. However, it is particularly disadvantageous about most of the tables having an integrated grill known from the state of the art that grill and table are tightly connected to one another. This entails that the grills embedded into a table are to be transported inconveniently and to be cleaned difficultly. Furthermore, known tables having an integrated grill provide only limited possible applications especially due to the tight connection of table and grill, such that the table especially is only suitable for having a barbecue.

DE 20 2007 016 724 U1 describes a dining table having an integrated grill comprising a container for the material to be heated embedded into the tabletop, wherein the container for the material to be heated is surrounded laterally by shielding walls which are supposed to protect the table from overheating.

US 2011/0162634 A1 describes a portable grill having adjoining table surfaces, which grill can be arranged on a table by means of pedestals.

U.S. Pat. No. 5,778,800 describes a portable folding table having a cooking zone arranged centrally within the tabletop.

DE 20 2014 106 122 U1 and DE 10 2014 118 888 each describe a grill installation kit comprising a bowl having a closed bottom and spacers arranged at the bottom, a perforated plate which can be arranged on the spacers and a grillage.

### OBJECT OF THE INVENTION

In view of the known state of the art it is the object of the present invention to provide a grill installation kit for an alternative table having a built-in grill which ensures an optimal air circulation around the material to be burned. It is a further object of the present invention to provide a grill installation kit providing a thermal decoupling from the surrounding tabletop when installed. It is still a further object of the invention to provide a grill installation kit in which the distance between the material to be burned and the grillage and therein the heat acting upon the food to be grilled placed on the grillage can be varied steplessly.

### GENERAL DESCRIPTION OF THE INVENTION

The present invention achieves the object by the features of the claims and especially by a grill installation kit for a table comprising
a bowl having openings in each sidewall and at the bottom,
an ash trap extending essentially in one plane, which ash trap can be arranged essentially in parallel to the bottom of the bowl thereon spaced by at least one spacer,
a firing tray having openings, which firing tray can be arranged essentially in parallel on top of the ash trap spaced by at least one spacer, and
a grillage.

The bowl of the grill installation kit according to the invention preferably is made of stainless steel and open at one side and has a capacity of e.g. 4 to 30 liters, especially 8 to 25 liters.

The bottom of the bowl which is opposite of its one open side as well as the four sidewalls of the bowl have openings. The openings can have any desired shape and especially can be circular, triangular, quadrangular, pentagonal or hexagonal, wherein the diameter of the individual openings especially is 0.1 to 2 cm, preferably 0.2 to 1 cm and particularly preferred 0.3 to 0.7 cm. Alternatively, the openings can also have the shape of slots e.g. extending within the sidewalls especially in parallel to the bottom of the bowl over the length or a part of the length of a sidewall.

In each sidewall of the bowl the openings can be spread across the entire surface of the sidewall or can extend only across a portion of the surface of a sidewall, for example across the lower half of a sidewall adjoining the bottom of the bowl or only in the region of the middle of a sidewall. Correspondingly, the openings within the bottom of the bowl can be spread across the entire surface of the bottom or can extend only across a portion of the bottom.

As a result of the bowl having openings within each sidewall and within the bottom, an optimal air circulation around the material to be burned arranged inside of the bowl is ensured, as the material to be burned can be flowed by air from all sides of the bowl. On the one hand this allows a rapid heat development of the material to be burned once lit and on the other hand contributes to the thermal decoupling of the bowl from a tabletop surrounding it, as the openings within each sidewall as well as within the bottom of the bowl have an effect comparable to cooling ribs. Thus even upon long-lasting heat development by the material to be burned the bowl does not heat up strongly.

At its side opposite the bottom the bowl preferably has a rim confining the open side of the bowl in a surrounding way. Beneath the rim, i.e. at the side of the rim facing the bottom of the bowl, there are preferably arranged several spacer elements, especially four spacer elements, which upon arrangement of the bowl within a recess of a tabletop space the bowl from the tabletop. Preferably, the rim of the bowl is essentially square or rectangular, optionally having rounded corners, wherein in each of the corners at least one spacer element is arranged. The spacer elements have a uniform length and extend in the direction of the bottom of the bowl, such that upon arrangement of the grill installation kit in a recess of a tabletop the bowl is spaced from the tabletop for example by 1 to 10 mm, preferably by 1 to 3 mm. In that an aerated distance between the stainless steel body of the bowl and the tabletop is created and a complete thermal decoupling of grill and table is caused. The spacer elements are made from a heat-resistant material, for example from heat-resistant rubber or silicone, and are mounted using heat-resistant adhesive. The geometry of the spacer elements is arbitrary, for example the spacer elements can have the shape of spheres, hemispheres, cubes, cuboids, cones, pyramids or parts of these.

The ash trap of the grill installation kit according to the invention preferably is made of stainless steel and in particular can be a metal sheet, e.g. having a base area which is a little bit smaller than the e.g. quadrangular base area of the bowl. For the purposes of the invention the term “angular” also comprises rounded corners, e.g. as the bowl depicted in the figures. In this embodiment as a metal sheet the ash trap comprises preferably partially circumferential or circumferential upstands at its side edges which minimize and prevent the falling of ashes onto the bottom of the bowl, respectively.

In an alternative embodiment the ash trap is designed as charcoal tray and aluminium tray, respectively.

According to the invention the ash trap is spaced from the bottom of the bowl by at least one spacer and can be arranged on the bottom of the bowl essentially in parallel thereto. Therein, the at least one spacer can be arranged on the bottom of the bowl such that upon being supported by the at least one spacer the ash trap lies in parallel to and spaced from the bottom of the bowl. However, it is more preferred that the at least one spacer is arranged at the ash trap and serves as pedestal by means of which the ash trap is positioned on the bottom of the bowl. In this embodiment the ash trap preferably has several spacers, e.g. 3, 4 or more spacers, which are arranged essentially perpendicularly to the plane in which the ash trap extends. By means of these spacers which e.g. have a length of 0.5 to 5 cm and especially of 1 to 2 cm, the ash trap can be positioned in parallel to and spaced from the bottom of the bowl.

In one embodiment the at least one spacer or several spacers, respectively, which e.g. can be formed pin-shaped or knob-like, and the ash trap are made of one single piece or are connected to the ash trap in a force-fitting, positive-fitting or firmly-bonded way, e.g. screwed together.

In a further embodiment in which the ash trap is designed as charcoal tray and aluminium tray, respectively, the at least one spacer is a carrier construction which is arranged or can be arranged between the ash trap and the firing tray. Thereby the carrier construction can be fastened at the firing tray or at the ash trap or can be fastened at none of these. As in this embodiment the carrier construction is the at least one spacer, the firing tray lies spaced from and essentially in parallel to the ash trap and to the bottom of the bowl upon arrangement on the carrier construction which is arranged on the ash trap.

Furthermore, the grill installation kit according to the invention comprises a firing tray having openings, which firing tray by means of at least one spacer can be arranged at a spacing from and essentially in parallel to the ash trap. Therein, the firing tray can be e.g. a perforated plate or an aluminium tray having openings.

In the embodiment of the firing tray being a perforated plate the surface of the perforated plate preferably corresponds essentially to the base area of the bowl, e.g. a quadrangular base area and a quadrangular base area the four corners of which are rounded, respectively. The openings arranged within the perforated plate can have an arbitrary shape and can spread across the entire surface of the perforated plate or only across a portion of the surface. Preferably, the openings are circular and in particular spread across the entire surface of the perforated plate. The diameter of the openings amounts to e.g. 0.2 to 4 cm, especially to 0.4 to 3 cm and more preferred to 0.5 to 2.5 cm. Alternatively, in a less preferred embodiment, the perforated plate can also have slots as openings extending across the entire surface of the perforated plate or only across a portion of the surface of the perforated plate. At its perimeter and at the side edges, respectively, the perforated plate optionally has a frame by which it is prevented that objects arranged on the perforated plate, especially the charcoal tray described below or the charcoal frame described below, laterally slip off the perforated plate. For this purpose, the frame can be arranged circumferentially or only partially circumferential at the perforated plate, wherein with an only partially circumferential arrangement of the frame a portion of the frame is arranged at each side of the perforated plate preferably. Preferably, the frame is arranged at the perforated plate essentially in perpendicular to the base area of the perforated plate and is made of one single piece with it and firmly connected with it, respectively.

The at least one spacer on which the firing tray can be arranged spaced from and essentially in parallel to the ash trap can be arranged at the ash trap or at the firing tray, wherein an arrangement at the ash trap is preferred. Preferably, the firing tray can be arranged on the ash trap on several spacers, especially on 3, 4 or more spacers, wherein the spacers preferably have a length of 3 to 10 cm, especially of 6 to 8 cm, by which the firing tray lies spaced from and essentially in parallel to the ash trap.

In a particularly preferred embodiment the spacers between the bottom of the bowl and the ash trap as well as the spacers between the ash trap and the firing tray are arranged at the ash trap and connected thereto in a force-fitting, positive-fitting or firmly-bonded way or are made of one single piece therewith. In this embodiment the at least one spacer which spaces the ash trap from the bottom of the bowl is arranged vertically at the plane in which the ash trap extends and comprises a length of about 0.5 to 5 cm and especially of about 1 to 2 cm. The at least one spacer which spaces the ash trap from the firing tray is also arranged vertically at the plane in which the ash trap extends, but at the side of the plane opposite of the spacer spacing the ash trap from the bottom of the bowl, in which plane the ash trap extends. This at least one spacer spacing the ash trap from the firing tray preferably has a length of approximately 3 to 10 cm and especially of approximately 6 to 8 cm.

In the aforementioned embodiment the at least one spacer arranged at the ash trap which spaces the ash trap from the firing tray can be connected to the firing tray in a force-fitting and/or positive-fitting way, e.g. in that the at least one spacer or preferably several spacers engage into one or more openings of the firing tray.

Furthermore, the grill installation kit according to the invention comprises a grillage which preferably is made of stainless steel, too. For example a customary grillage having parallel struts as well as optional cross struts can be used as grillage. Preferably, the grillage has handles at two opposing sides by means of which it can be arranged on the open side of the bowl. Therefore, the distance between both handles preferably is bigger than the distance between a sidewall of the bowl and the opposing sidewall. Therefore, the grillage especially can be arranged on the bowl by laying it on the open side of the bowl, therein covering the bowl, wherein a covering of the open side of the bowl can also be an only partial covering of the open side of the bowl. In a preferred embodiment the handles at the grillage and the grill surface are offset, especially in parallel, wherein the grill surface and the handles are connected by distance elements which at opposing sides of the grill surface are arranged rectangularly both at the grill surface and at the handles. Therefore, upon arrangement of the grillage covering the open side of the bowl, the handles of the grillage preferably lie on top of the bowl, whereas the grill surface is hanging into the bowl about the length of the distance elements, e.g. approximately 1 to 3 cm.

According to a preferred embodiment the firing tray and the bottom of the bowl are connected to one another by a screw connection with which the distance of the firing tray to the bottom of the bowl is adjustable. In this embodiment, the firing tray is also height-adjustable. By a variation of the distance between the firing tray and the bottom of the bowl there automatically occurs a variation of the distance between the firing tray and the grillage, too. Thus the grill installation kit according to the invention allows a continuous height-adjustment of the firing tray upon preferably manual operation of the screw connection between the firing tray and the bottom of the bowl, e.g. by means of a wing nut arranged at the lower surface of the bowl. Thus with a grill installation kit according to the invention the distance between the material to be burned and the grillage can be adjusted individually depending on the required heat.

Optionally, in the embodiment having a height-adjustable firing tray the at least one spacer between the firing tray and the ash trap and/or the at least one spacer between the ash trap and the bottom of the bowl is a spring-mounted spacer which is adjustable in its length.

The elements described so far, i.e. the bowl having openings within the sidewalls and within the bottom, the ash trap, the firing tray and the grillage, are essential components of the grill installation kit according to the invention. Additional optional components are described hereinafter.

In a preferred embodiment a grill installation kit according to the invention further comprises either a charcoal tray or a charcoal frame. Preferably, the charcoal tray contains or is made of aluminium and has a bottom having openings as well as sidewalls optionally having openings. Preferably, the base area of the bowl is smaller than the surface confined by an optionally circumferential or partially circumferential frame of the firing tray, such that the bowl with its bottom can be arranged on the firing tray and within the frame arranged at the firing tray.

Preferably, the charcoal frame usable as an alternative to the charcoal tray is made of stainless steel and confines a surface smaller than the surface confined by the preferably circumferential or partially circumferential frame of the perforated plate, such that the charcoal frame can be arranged on the firing tray and within the frame arranged at the firing tray.

Material to be burned, e.g. charcoal, can be arranged within the charcoal tray or within the alternative charcoal frame.

A smaller cleaning effort is an advantage of the charcoal tray over the charcoal frame, as a new charcoal tray can be used for each grilling process. On the other hand, the charcoal frame is more environmentally friendly and like the further components of the grill installation kit which preferably are made of stainless steel is easy to clean in the dishwasher.

In a preferred embodiment the grill installation kit according to the invention consists of the bowl, the ash trap, the firing tray, the grillage as well as the charcoal tray or the charcoal frame.

For a stepless elevation of the grill, i.e. for a bigger spacing of the grillage from the charcoal tray containing the material to be burned or from the charcoal frame having the material to be burned contained therein, the grill installation kit optionally further has grillage spacers. Preferably, these grillage spacers are cuboid-shaped and have notches in at least one lateral surface, in which notches the handles of the grillage can be arranged having positive fit. Especially, the cuboid body of the grillage spacers has three different edge lengths and preferably has notches for intake of the handle arranged at the grillage on at least two lateral surfaces which especially are not congruent, i.e. not opposing one another. In a preferred embodiment a grillage spacer has notches at two opposing ends of a lateral surface and has notches at two opposing ends of an adjoining lateral surface, too. Alternatively, a grillage spacer can also have notches at two opposing ends of each lateral surface with the exception of the front surfaces, e.g. in the form of a circumferential groove.

By arrangement of two grillage spacers alongside of two opposing sides of the bowl and laying the handles of the grillage in the notches of the grillage spacers, a bigger distance between the grillage and the material to be burned is created, wherein preferably the distance can be varied by rotation of the grillage spacers by 90 degrees along their longitudinal axis. Thus using the grillage spacers, the grillage can be elevated in two steps such that it can be grilled having less heat, too.

As a further optional component the grill installation kit according to the invention comprises a warming rack preferably made of stainless steel. The warming rack has a grill surface especially consisting of parallel struts, the grill surface having laterally arranged handles and pedestals, and on its pedestals can be positioned on the grillage, preferably by force-fitting or positive-fitting connection of the pedestals to one or more of the struts of the grillage, respectively. In addition to the warm-keeping function the warming rack also fulfills the function of an elevated grill and therefore is suitable for low-temperature grilling, e.g. of bread.

Further, the grill installation kit according to the invention preferably has mounting accessories for integrating the grill into a conventional table, e.g. a garden table, a beer garden table or a high table. The mounting accessories especially comprise template bars having grooves, cover profiles and fasteners, especially four template bars having grooves as well as four cover profiles and fasteners. Preferably, the template bars each have a groove in parallel to their longitudinal sides, which groove e.g. runs centrically between the longitudinal sides. The end faces of the template bars are preferably arranged at an angle to the longitudinal axis of the template bars, especially at an angle of 45 degrees. Thus upon arrangement with adjoining front surfaces, the template bars as well as the grooves arranged therein confine a rectangle, wherein upon separating the surface of the tabletop confined by the grooves from the tabletop, e.g. using a jigsaw, a recess in the tabletop can be generated in a process for producing a table having an integrated grill, in which recess the bowl of the grill installation kit according to the invention can be arranged.

The cover profiles of the mounting accessories are essentially angular and preferably have several openings distributed over the whole length for arrangement of and intake of fasteners, respectively. Preferably, the cover profiles have essentially the same length as the template bars and after separating of a partial surface of the tabletop along the cutting edges, i.e. either along the cutting edges around the removed surface of the tabletop or along the cutting edges of the recess in the tabletop, can be fastened, e.g. can be connected to the tabletop or to the removed surface of the tabletop by means of nails or screws. Therefore, the mounting accessories comprise fasteners, e.g. squares, attachments, screws and/or nails, for fastening of the template bars and of the cover profiles to the tabletop. Thanks to the mounting accessories the element removed from the tabletop remains intact and can be reinserted into the table if the bowl and the remaining needed grill accessories are no longer required such that the look of the table is essentially preserved. Alternatively, the bowl, optionally with further grill accessories, can remain within the table, wherein in this case the grill installation kit also comprises a stainless steel lid which preferably can be positioned on the bowl having positive fit and thus covers its open side.

Especially for the arrangement of a grill installation kit according to the invention within a plastic table the installation kit optionally has a universal mounting frame which, however, can also be mounted in wooden tables. The universal mounting frame is made of a T-shaped stainless steel profile and can be arranged along the cutting edges of a surface removed from a tabletop. Within the frame the bowl together with further components of the grill installation kit according to the invention can be arranged. In this embodiment, too, the bowl can be removed from the table after grilling and the element removed from the tabletop can be fastened again in the universal mounting frame from below, e.g. by means of spring clamps, whereby the look of the table is essentially preserved.

Furthermore, the grill installation kit according to the invention optionally also comprises a second bowl without openings in the sidewalls and at the bottom, having otherwise identical dimensions to the bowl having openings in the sidewalls and at the bottom. This second bowl serves as exchange body which can be put into the recess in the tabletop instead of the first bowl serving as grilling body. Preferably, the second bowl is made of stainless steel, too, and is suitable for example for intake of table decoration, as storage space or for cooling of beverages. Due to the identical dimensions of both bowls the optional stainless steel lid is also suitable for the second bowl, i.e. for example can be positioned thereon having positive fit, too.

As a further optional component the grill installation kit according to the invention comprises an electrically-operated heating element which with its end connectable to a power source can be guided through a sidewall of the bowl. In this embodiment the grill is not used as a charcoal grill but as an electric grill. Accordingly, the ash trap as well as the firing tray are dispensable in this embodiment.

In a preferred embodiment the grill installation kit according to the invention further has two side panels having recesses, which side panels can be arranged at opposing sides of the bowl. As a result of the side panels having a thickness of only few millimeters, they can be inserted into the recess in the tabletop especially in parallel to a sidewall of the bowl. The recesses in the side panels can be openings in the side panels or recesses along a longitudinal side of the side panels, e.g. notches along a longitudinal side of the side panels. Preferably, the side panels are made of stainless steel.

In embodiments having side panels the grill installation kit according to the invention further comprises spits, especially made of stainless steel, which in the region of their opposing ends can be arranged in the recesses of two opposing side panels, wherein the part of the spits located between the ends is hanging over the grillage. In this embodiment the grill installation kit is especially suitable for grilling and cooking of vegetable skewers or meat skewers, respectively.

In addition to or as an alternative to the aforementioned side panels with corresponding spits the grill installation kit according to the invention can also have a motor-driven spit attachment. This also comprises two side panels having recesses and notches, respectively, for intake of spits, which side panels preferably are connected to one another, e.g. by two connecting bridges running perpendicularly between the side panels at their ends. The spit attachment is connected to a motor, for example via a USB port.

In a further embodiment the grill installation kit according to the invention comprises raclette accessories. This comprises a grill plate which on two side panels can be arranged over the grillage. The side panels can especially have openings and notches, respectively. Optionally, the side panels described with reference to the spit grilling accessories can be used. Preferably, the grill plate is made of cast material and is essentially square or rectangular and has handles on opposing sides, especially handles which are made of one single piece with the grill plate. As the grill plate has a surface which corresponds essentially to the surface confined by the sidewalls of the bowl or which is slightly larger than that, respectively, the grill plate with the handles can be arranged on the side panels arranged at opposing sides of the bowl, wherein the grill plate can be positioned essentially in parallel to the grillage spaced thereon. The raclette accessories preferably also comprises grill pans as well as sliders as they are known from a conventional raclette. With the grill plate laying on the side panels, the grill pans can be positioned on the grillage, i.e. in the space between grill plate and grillage. Therein due to the radiant heat of the food being grilled the heavy cast material of the grill plate acts as a raclette device having electrical top heat. Therefore, for example vegetables and potatoes can be gratinated in the pans, while meat, fish or the like can be fried on the grill plate.

As the grill installation kit according to the invention is not only usable as a grill but is very versatile as described before, a preferred embodiment of the invention consists of a set which apart from the bowl, the ash trap, the firing tray and the grillage with optional charcoal tray and optional charcoal frame as well as the mounting accessories also contains any number of the further aforementioned components, especially the grillage spacers, a second bowl without openings in the sidewalls, a stainless steel lid, a warming rack, the spit grilling accessories having spits and side panels, the motor-driven spit attachment having spits and/or the raclette accessories. It is a special advantage of this set that the individual accessories can be combined variably with the basic accessories, i.e. the bowl, the ash trap, the firing tray and the grillage. Thus the set allows differing possible applications, especially as grill, beverage cooling, table decoration, storage space, raclette and/or spit grill, wherein the look of the tabletop in the recess of which the bowl together with the further components can be arranged remains essentially preserved due to the mounting accessories.

In a further preferred embodiment of the invention the grill installation kit according to the invention is arranged within a recess of a tabletop of a table. Therein the table especially is a table having a tabletop made of or containing wood, e.g. a garden table or a beer garden table, or alternatively a plastic table. Optionally, the tabletop can consist of several elements, e.g. of at least two elements and preferably of three to five elements, wherein each element is connected articulatedly and preferably force-fitting to at least one further element along a side edge, e.g. by means of a hinge. In this embodiment the individual elements each comprise a portion of the tabletop, especially a rectangular surface of the tabletop, wherein in one of the elements the recess with the grill installation kit arranged therein is contained. The individual elements can be arranged forming a plane, i.e. a flat tabletop. However, due to the articulated connection the elements with the exception of the element having the integrated grill can be arranged at an angle of 90 degrees with respect to the element having the integrated grill. Thus a table having an integrated grill installation kit can be stored or transported with minimum space requirements, wherein due to the articulated connection of the elements the tabletop comprising the individual elements can always be rearranged to a tabletop having a bigger surface, too. In this space-saving embodiment the grill installation kit according to the invention integrated into a table is especially suitable for transporting, for example by means of a handcart or as a handcart attachment.

With each embodiment of the grill installation kit according to the invention which is arranged in a recess of a tabletop, grilling is possible safely and harmlessly, especially due to the bowl having openings in each sidewall and at the bottom, allowing an optimal air circulation around the material to be burned, as well as due to the spacer elements arranged at the lower rim of the bowl which spacer elements hold the bowl at a distance to the tabletop upon arrangement of the bowl in a recess of a tabletop and therefore thermally decouple the bowl from the tabletop surrounding it.

As a further optional heat protection the grill installation kit according to the invention also comprises shielding strips made from a heat-resistant material, which shielding strips can be arranged at the cutting edges of the recess prior to the arrangement of the grill installation kit in a recess of a tabletop. Preferably, the shielding strips are made of sheet metal or stainless steel and can comprise openings, e.g. for fastening by means of fasteners. Stainless steel perforated tapes are preferred shielding strips which can be mounted along the cutting edges of the recess using nails.

### DETAILED DESCRIPTION OF THE INVENTION

The invention is now described in greater detail by means of examples and with reference to the figures in which schematically

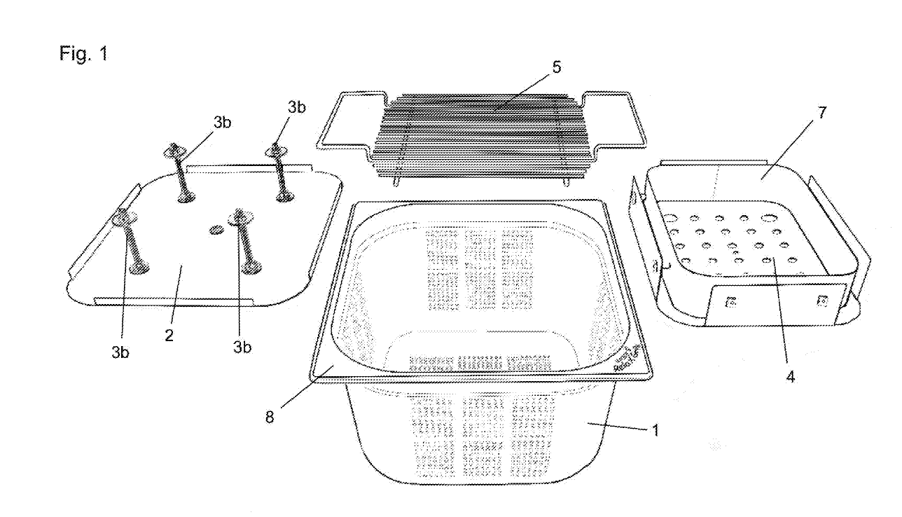

FIG. 1 shows a grill installation kit according to the invention,

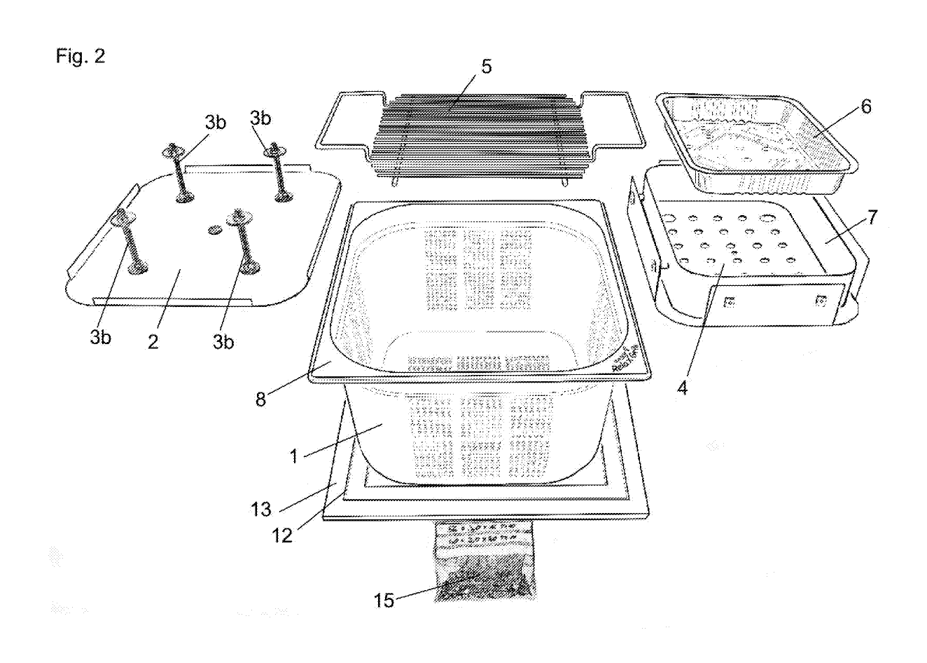

FIG. 2 shows a grill installation kit according to the invention comprising mounting accessories,

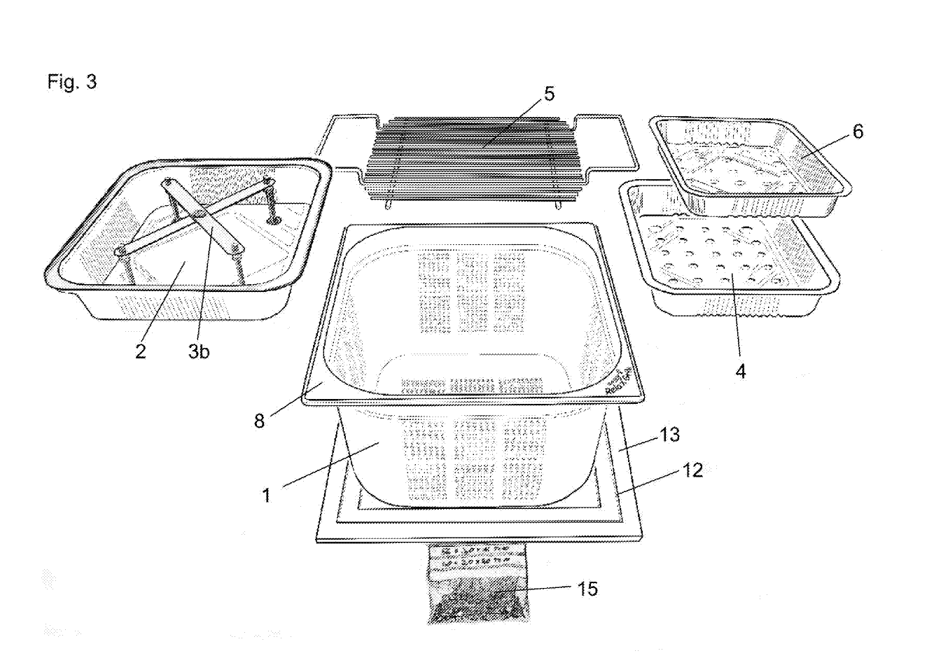

FIG. 3 shows a further embodiment of a grill installation kit according to the invention comprising mounting accessories,

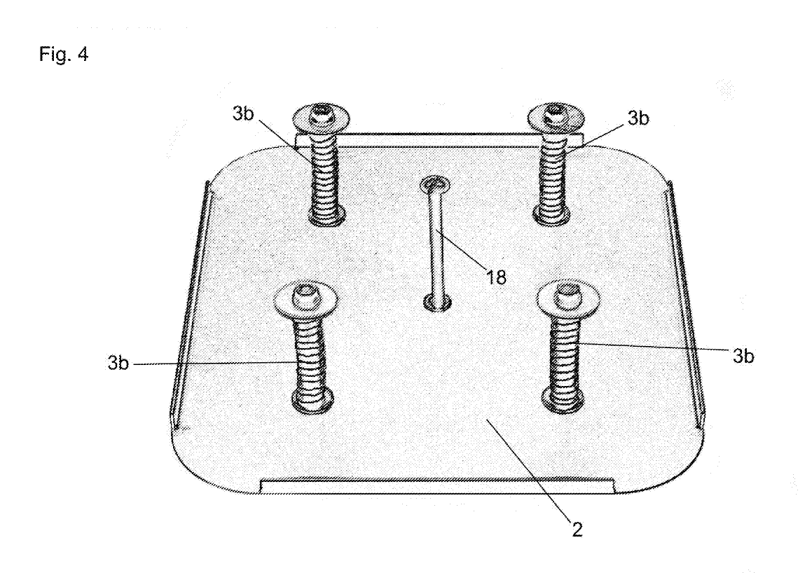

FIG. 4 shows an ash trap of a grill installation kit according to the invention,

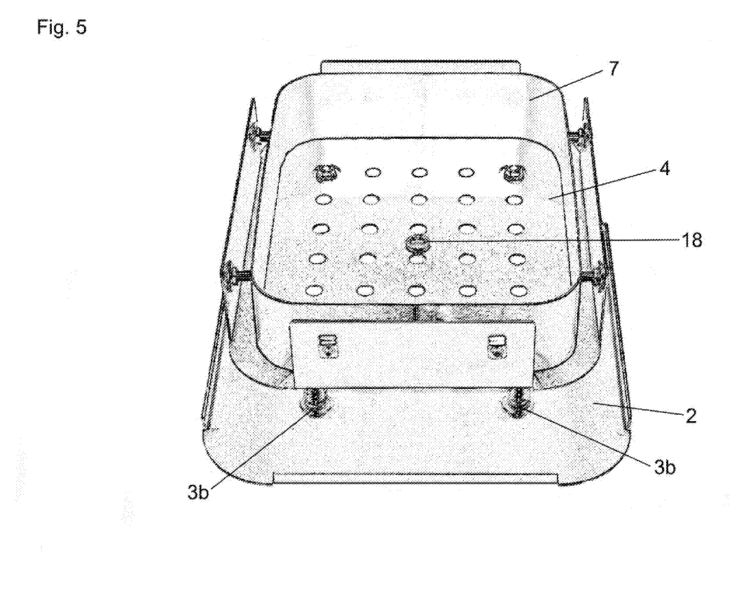

FIG. 5 shows components of a grill installation kit according to the invention,

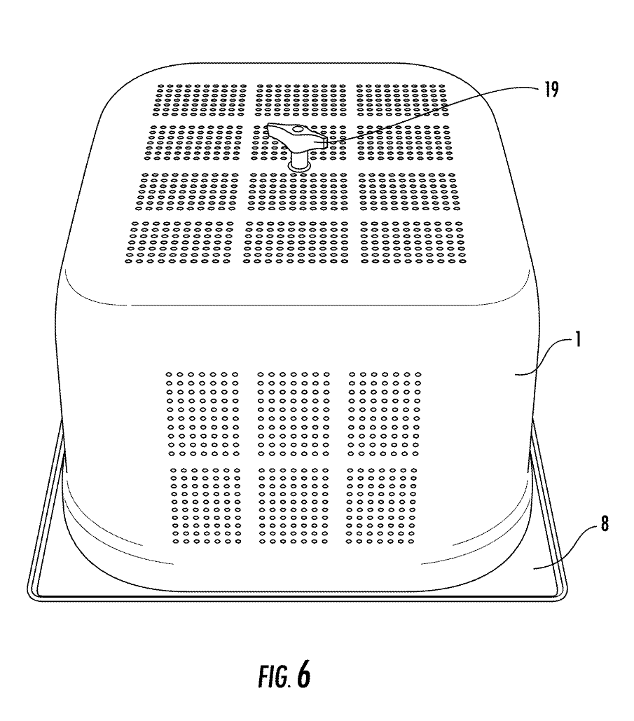

FIG. 6 shows a bowl of a grill installation kit according to the invention,

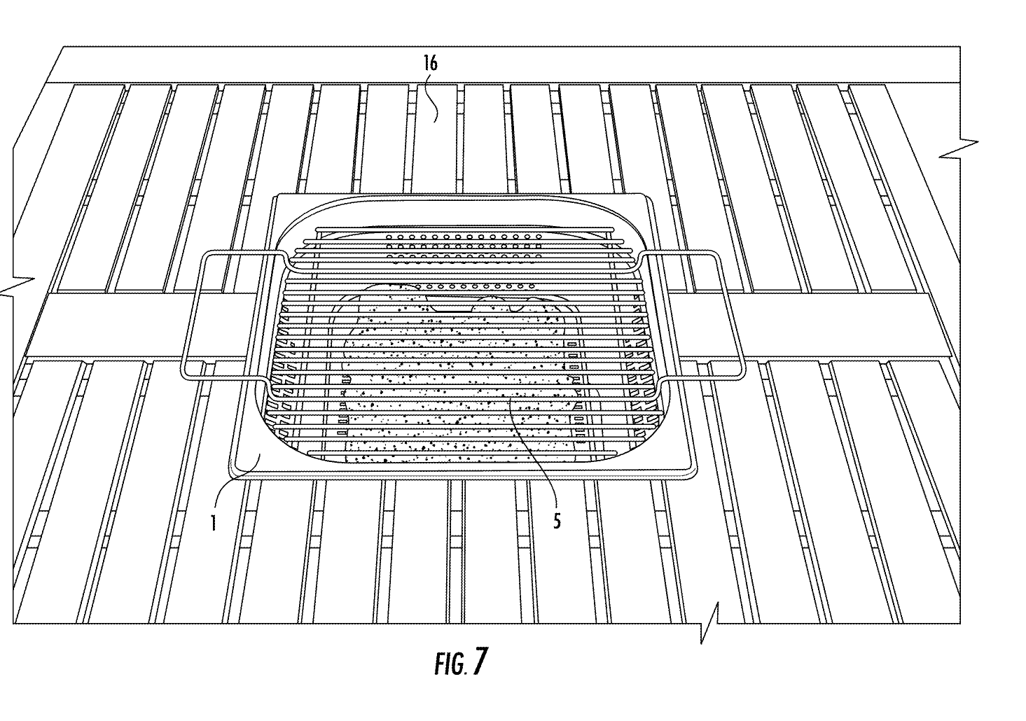

FIG. 7 shows a grill installation kit according to the invention when installed,

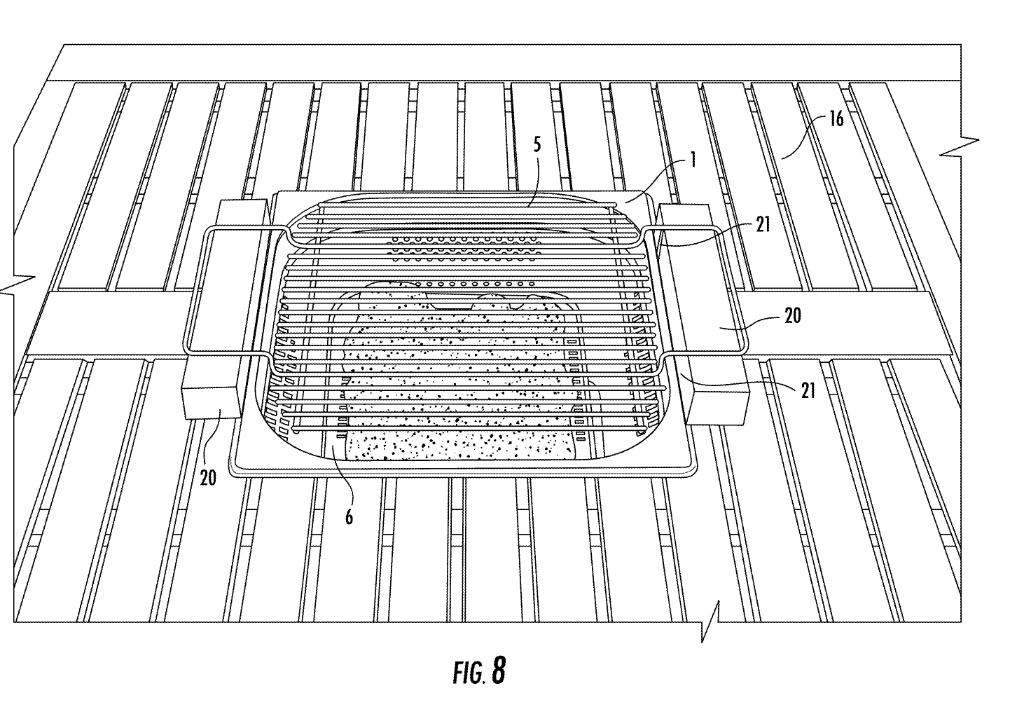

FIG. 8 shows a further embodiment of a grill installation kit according to the invention when installed,

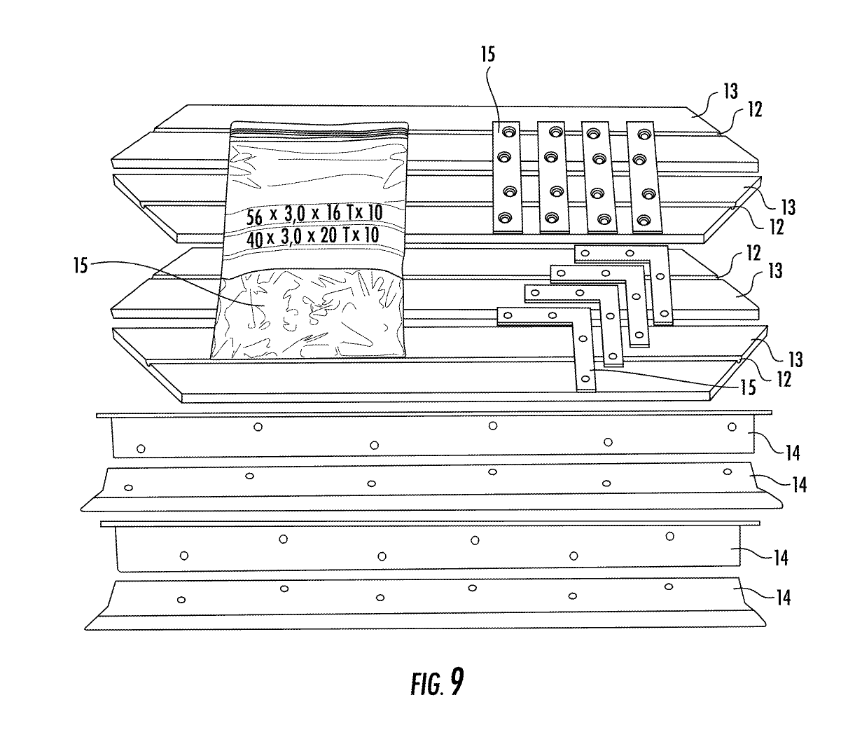

FIG. 9 shows the mounting accessories of a grill installation kit according to the invention,

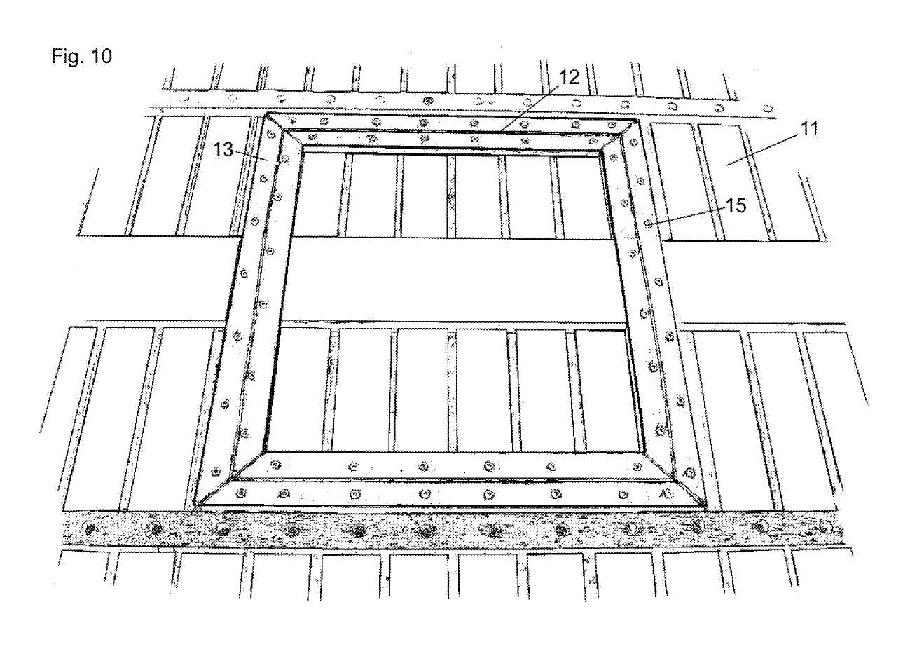

FIG. 10 shows template bars arranged at the tabletop,

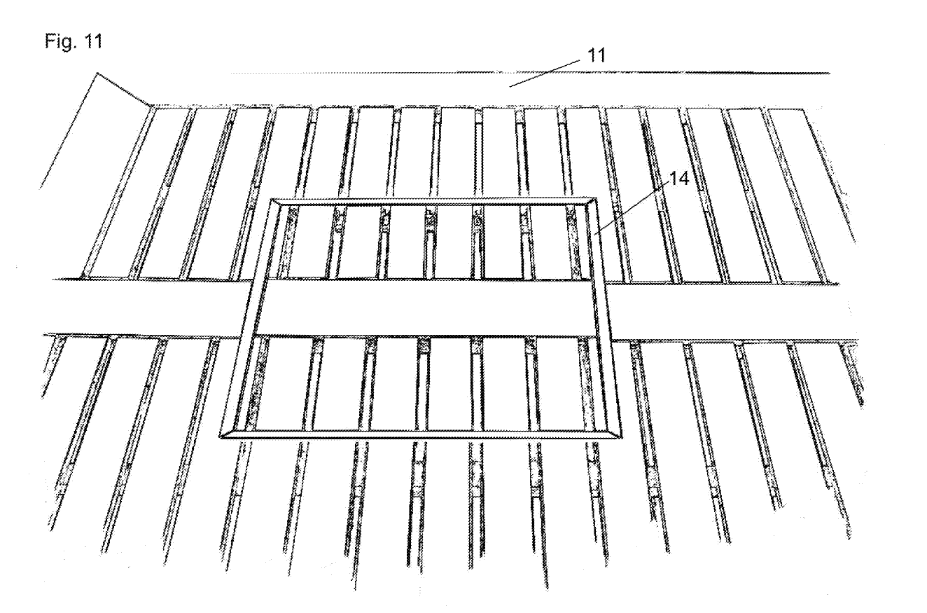

FIG. 11 shows a tabletop having an essentially preserved look,

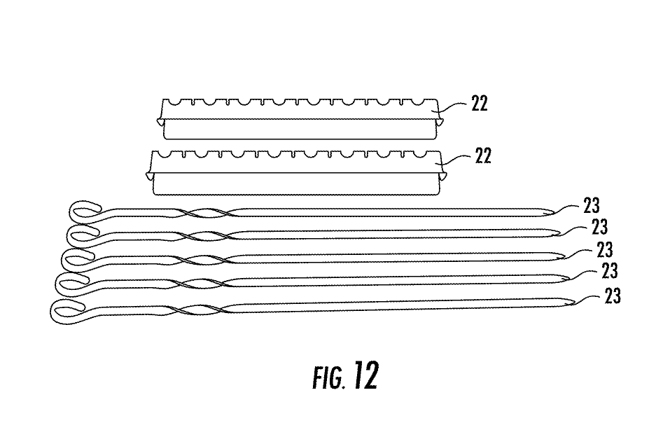

FIG. 12 shows the spit grilling accessories of a grill installation kit according to the invention,

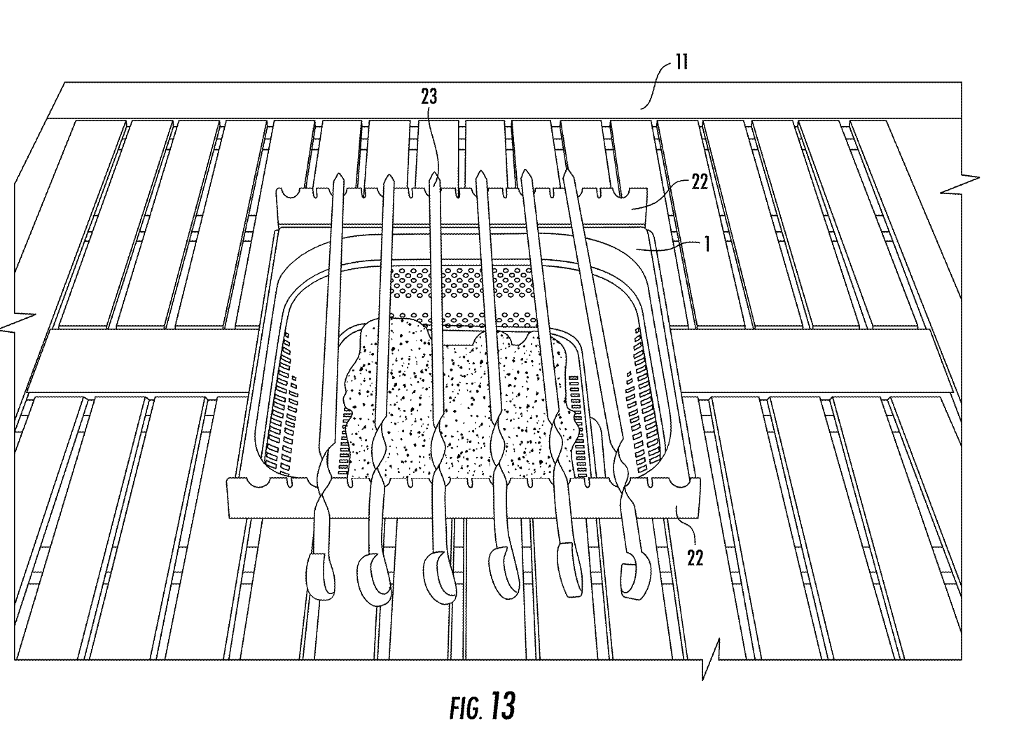

FIG. 13 shows a grill installation kit according to the invention comprising spit grilling accessories,

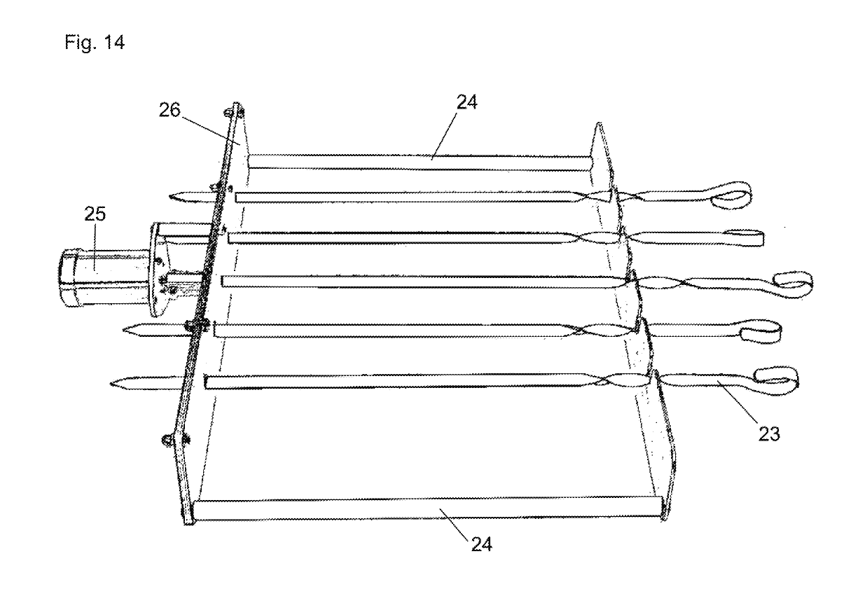

FIG. 14 shows a motor-driven spit attachment,

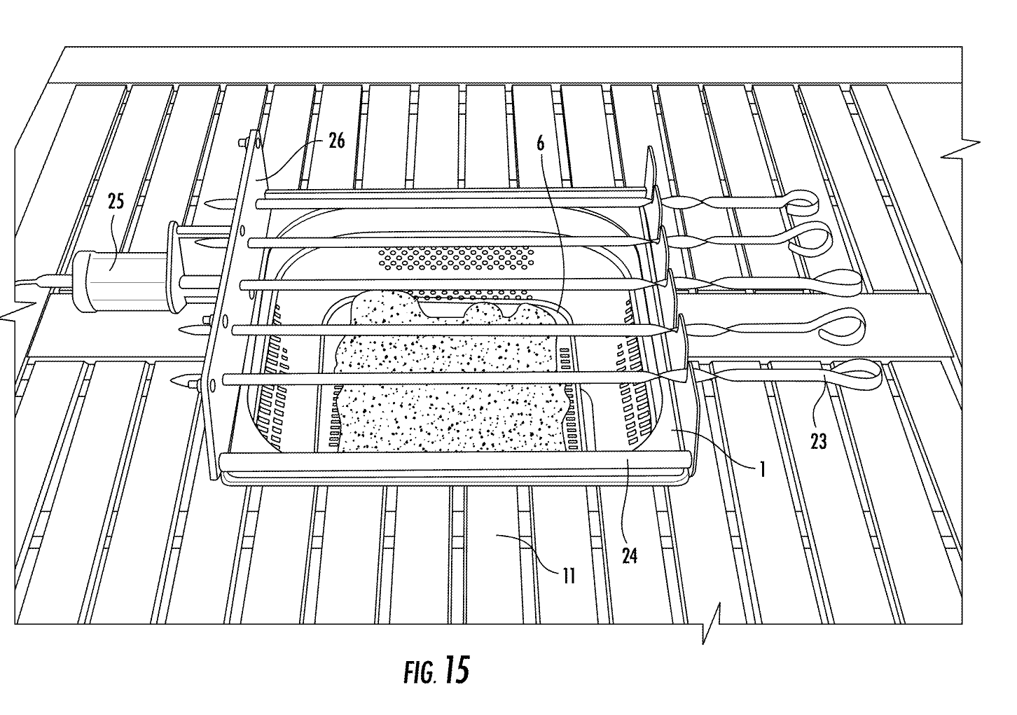

FIG. 15 shows a grill installation kit according to the invention comprising a motor-driven spit attachment when installed,

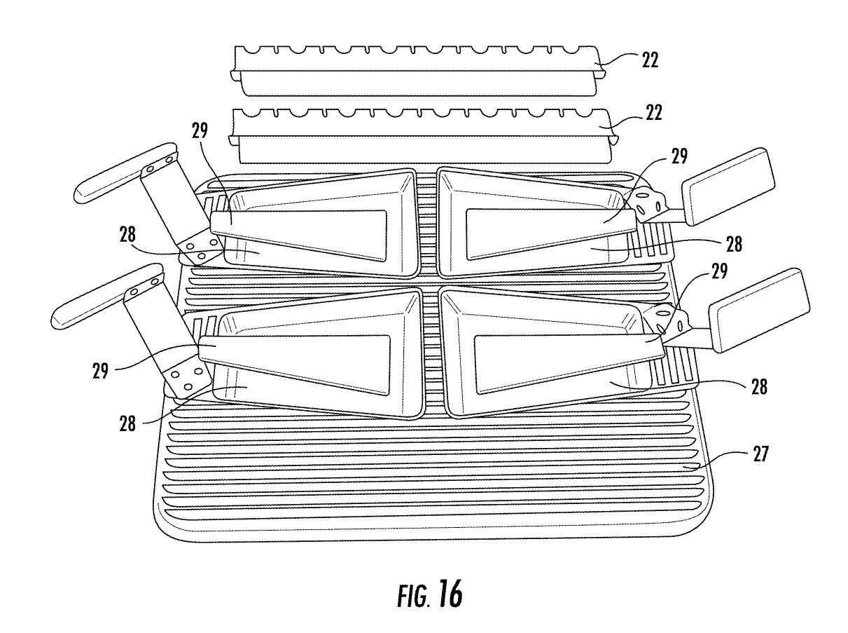

FIG. 16 shows the raclette accessories of a grill installation kit according to the invention,

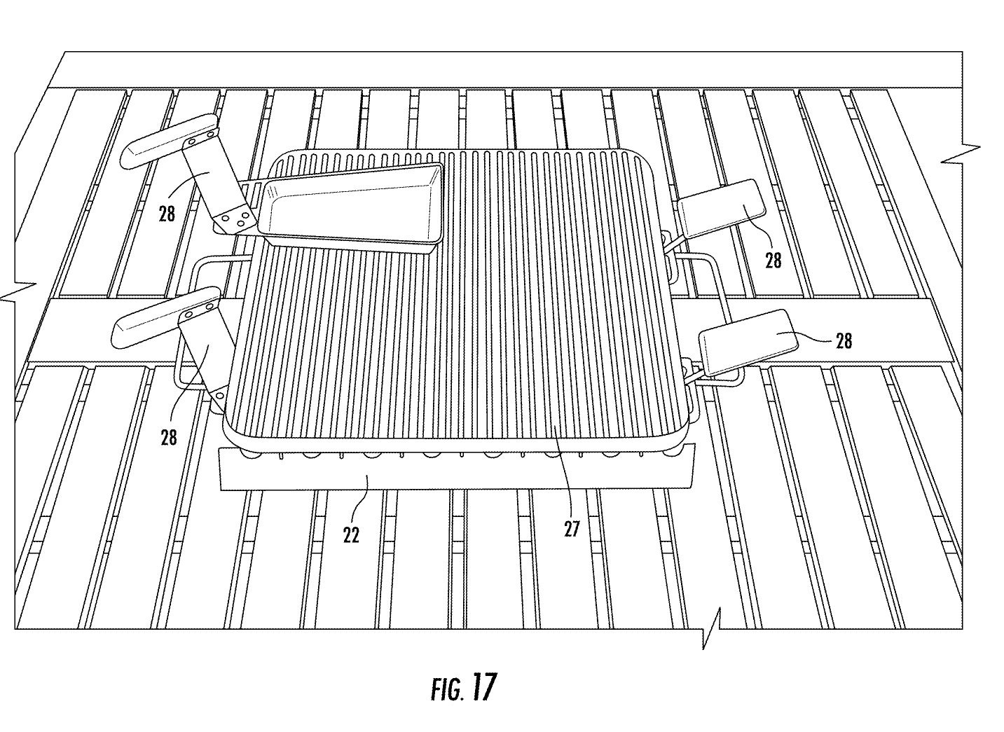

FIG. 17 shows a grill installation kit according to the invention comprising raclette accessories when installed,

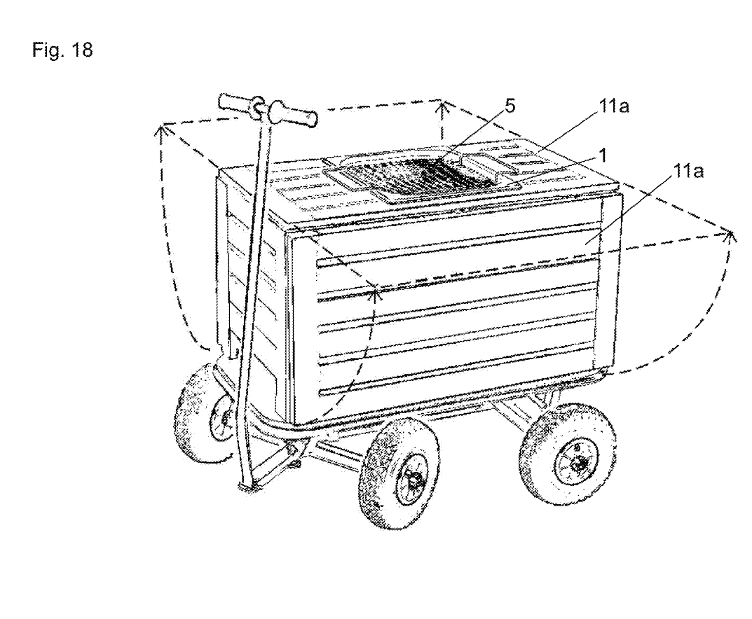

FIG. 18 shows an alternative embodiment of a grill installation kit according to the invention,

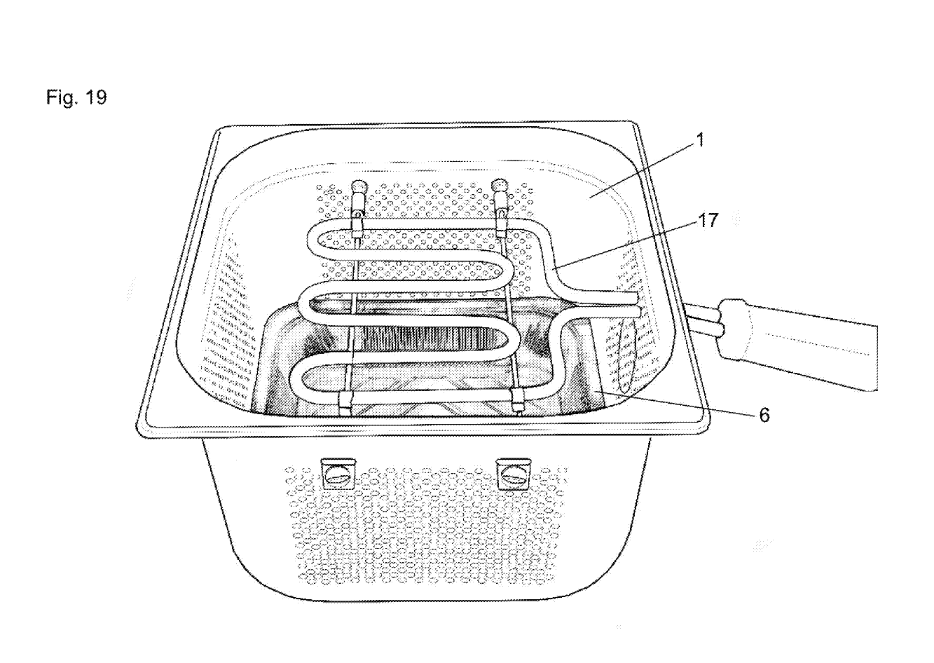

FIG. 19 shows components of a grill installation kit according to the invention, and

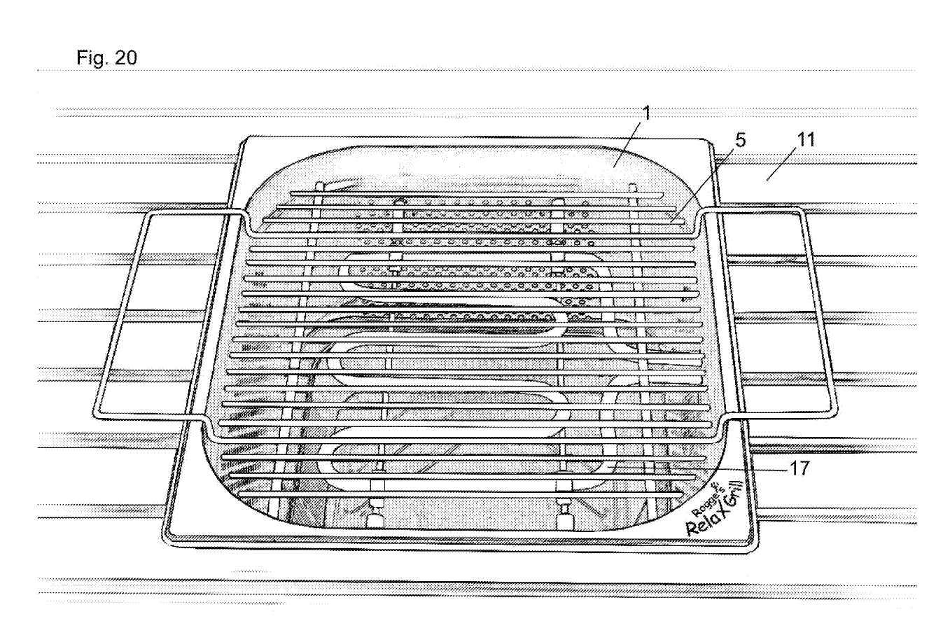

FIG. 20 shows a grill installation kit according to the invention comprising an electrically-operated heating element when installed.

In the figures, identical reference numerals denote functionally identical components.

FIG. 1 shows a grill installation kit according to the invention comprising a bowl 1, an ash trap 2, a firing tray 4, a grillage 5 and a charcoal frame 7. At its four sidewalls as well as at its bottom the bowl 1 has openings, which in the depicted embodiment spread across approximately half of each sidewall to three quarters of each sidewall and essentially mass around the center of each side surface.

In the depicted embodiment the ash trap 2 is formed as a stainless steel sheet having partially circumferential upstands at its perimeter. Four spacers 3b are arranged at the ash trap 2, spacing the ash trap from the firing tray 4 when installed. The at least one spacer 3a which is arranged at the side of the ash trap 2 opposite the at least one spacer 3b is depicted neither in this nor in the other figures.

In the depicted embodiment the firing tray 4 is a perforated plate. This has a rectangular base area the corners of which are rounded and has openings which are arranged distributed across the entire surface of the perforated plate. At its perimeter the perforated plate has a frame which is arranged partially circumferential at the perimeter of the perforated plate 3 essentially in perpendicular thereto. Preferably, the base area of the perforated plate 3 is essentially congruent to the bottom of the bowl 1 or minimally smaller than the surface formed by the bottom of the bowl 1.

The charcoal frame 7 consists of side surfaces arranged essentially in perpendicular to one another, wherein the side surfaces confine a surface between one another which is smaller that the surface confined by the frame at the firing tray 4. Therefore, the charcoal frame 7 can be arranged within the frame arranged at the firing tray 4.

The grillage 5 has an essentially rectangular grill surface the four corners of which are rounded and has parallel struts as well as two cross struts in the depicted embodiment. At two opposing sides the grillage 5 has handles which are arranged offset and in parallel at the grillage 5. Thereby the grill surface and the handles are connected to one another by spacer elements which at opposing sides of the grill surface are arranged in perpendicular thereto and in perpendicular to the handles. Upon arrangement of the grillage 5 on the bowl 1 the grillage 5 with its handles is supported by opposite sides of the bowl 1, wherein the grill surface of the grillage 5 is hanging into the bowl 1 about the length of the distance elements.

FIG. 2 shows a grill installation kit according to the invention which in addition to the components from FIG. 1 also comprises a charcoal tray 6 as well as mounting accessories.

The charcoal tray 6 is a conventional aluminium tray having openings in the bottom. The base area of the charcoal tray 6 is smaller than the surface confined by the frame of the firing tray 4, such that the charcoal tray 6 with its bottom can be arranged within the partially circumferential frame on the firing tray 4.

In the depicted embodiment the mounting accessories comprise four template bars 13 as well as fasteners 15. The template bars 13 each have a groove 12 running spaced to and essentially in parallel to the longitudinal sides of the template bars 13. The end faces of the template bars 13 are arranged at an angle to the longitudinal sides of the template bars 13, especially at an angle of 45 degrees. Upon arrangement of the template bars 13 such that each front surface of a template bar 13 is brought into congruence to a front surface of one of the other template bars 13, the template bars 13 and the grooves 12 arranged therein confine a rectangular surface.

FIG. 3 shows a further embodiment of a grill installation kit according to the invention which in comparison to FIG. 2 has an alternative ash trap 2 as well as an alternative firing tray 4. In the depicted embodiment, the ash trap 2 is a charcoal tray and an aluminium tray, respectively, having a closed bottom, and the at least one spacer 3b is built as a carrier construction which can be arranged between the ash trap 2 and the firing tray 4. Upon arrangement of the firing tray 4 on the carrier construction the firing tray 4 lies spaced from and essentially in parallel to the ash trap 2.

In the depicted embodiment the firing tray 4 is an aluminium tray having openings in the bottom. Within the sidewalls of the aluminium tray which forms the firing tray 4 a further smaller charcoal tray can be arranged, the charcoal tray also having openings in the bottom but having a smaller base area than the tray forming the firing tray 4.

FIG. 4 shows an ash trap 2 of a grill installation kit according to the invention. This is formed as a stainless steel sheet and has partially circumferential upstands at its perimeter. Four spacers 3b are arranged at the ash trap 2 which are spring-mounted and therefore variable in their length. Approximately centrically the ash trap 2 has an opening through which a screw connection 18 is arranged. This on the one hand is arranged at the firing tray 4 and on the other hand at the bottom of the bowl 1 (not depicted), whereby the distance between the firing tray 4 and the bottom of the bowl 1 is variable.

FIG. 5 shows the height-adjustable arrangement of the firing tray 4 on the ash trap 2. Centrically, the firing tray 4 has the screw connection 18 which is guided through an opening in the ash trap 2 as depicted in FIG. 4 and can be actuated by the wing nut 19 at the bottom of the bowl 1. This wing nut is arranged centrically at the lower surface of the bowl 1 as depicted in FIG. 6. Upon actuation of the wing nut 19 the distance between the bottom of the bowl 1 and the firing tray 4 is varied.

FIG. 7 shows a grill installation kit according to the invention when installed in which the bowl 1 with its rim confining the open side of the bowl 1 is supported by the tabletop of a table 16, whereas the rest of the bowl 1 is arranged within a recess of the tabletop and is hanging in the recess, respectively.

The grillage 5 with its handles is supported by two opposing sides of the bowl 1, wherein the grill surface of the grillage 5 is hanging into the bowl 1 about the length of the distance elements arranged between handle and grill surface.

FIG. 8 shows the grill installation kit of FIG. 7 which in addition comprises two grillage spacers 20. The grillage spacers 20 each are cuboid-shaped and in the region of their opposing ends have circumferential grooves 21 in which the handles of the grillage 5 can be arranged. By means of the grillage spacers 20 the grill surface of the grillage 5 is further away from the material to be burned arranged on the firing tray 4 such that it can be grilled at lower heat.

FIG. 9 shows the mounting accessories of a grill installation kit according to the invention comprising four template bars 13 having grooves 12 arranged therein, four cover profiles 14 as well as attachment pieces, squares and screws as fasteners 15.

The grooves 12 in the template bars 13 run essentially in parallel to the longitudinal sides of the template bars 13, having approximately the same distance to each of the longitudinal sides of the template bars 13. In the depicted embodiment the four template bars 13 are identically constructed and have two opposing end faces each which are arranged at an angle of 45 degrees to one of the longitudinal sides and at an angle of 135 degrees to the other longitudinal side. Therefore, upon arrangement of the template bars 13 having adjoining front surfaces a square surface is confined by the template bars 13.

The cover profiles 14 are angular profile mouldings having openings for intake of fasteners 15.

As fasteners 15 the mounting accessories in the depicted embodiment have squares, attachment pieces and screws.

FIG. 10 shows a tabletop 11 having template bars mounted thereon. The template bars 13 are arranged at the lower surface of a tabletop 11 by means of fasteners 15, wherein the template bars 13 confine a rectangular surface between one another. The fasteners 15 are arranged in the template bars 13 on both sides of the grooves 12 running in the template bars 13 and connect the template bars to the tabletop 11. For generating a recess for intake of a bowl 1 serving as grilling body the surface of the tabletop 11 confined by the grooves 12 would have to be removed by sawing or cutting of the template bars 13 and the table 16 connected thereto alongside of the grooves 12.

FIG. 11 shows a tabletop 11 having a recess in which a surface of the tabletop 11 removed from the tabletop 11 was reinserted. Cover profiles 14 are arranged along the cut surfaces in the tabletop 11 and confine the surface removed from the tabletop 11 between one another.

FIG. 12 shows the spit grilling accessories of a grill installation kit according to the invention. The spit grilling accessories comprises two side panels 22 as well as spits 23. In the depicted embodiment the side panels 22 have recesses in the form of notches at one of their longitudinal sides. The longitudinal side of the side panels 22 opposite the longitudinal side having the notches has a thickness of only few millimeters, such that the side panels 22 can be clamped and arranged, respectively, between the bowl 1 and the tabletop 11 at opposing sides of the bowl 1, especially in parallel to two opposing sidewalls of the bowl 1.

FIG. 13 shows a grill installation kit according to the invention comprising the spit grilling accessories depicted in FIG. 12 when installed.

FIG. 14 shows a motor-driven spit attachment 26 having spits 23 arranged therein. The spit attachment 26 comprises two side panels, one of which having recesses and the other having notches at one longitudinal side. The side panels are arranged in parallel to one another and connected to one another by connecting bridges 24, wherein the side panels and the connecting bridges 24 are especially made of one single piece. The spit attachment further has a USB port 25 by which the spit attachment can be connected to a motor.

The spits 23 with their pointed ends are guided through the recesses in one of the side panels and in the region of their opposing ends are supported by the notches in the other side panel.

FIG. 15 shows a grill installation kit according to the invention comprising the motor-driven spit attachment depicted in FIG. 14 when installed.

FIG. 16 shows the raclette accessories of a grill installation kit according to the invention. This comprises two side panels 22 which in the depicted embodiment have recesses in the form of notches at one of their longitudinal sides. Furthermore, the raclette accessories comprise a grill plate 27 as well as grill pans 28 and sliders 29.

FIG. 17 shows a grill installation kit according to the invention comprising the raclette accessories depicted in FIG. 16 when installed. The grill plate 27 with its bead having a height of approximately 5 millimeters running at the lower surface is arranged on the side panels 22 such that the bead engages into the notches of the side panels 22 and forms a positive-fitting connection to these, whereby a shifting of the grill plate 27 is prevented.

FIG. 18 shows a grill installation kit according to the invention in the form of a handcart attachment. In the depicted embodiment the tabletop 11 consists of three elements 11a. In the recess of the middle element 11a the bowl 1 with the further components of the grill installation kit is arranged. At two opposing longitudinal sides of this element 11a the element 11a is articulatedly connected to a further element 11a without a recess, respectively. By a swivel movement these lateral elements 11a can be brought into a plane with the middle element 11a and together with this element form the tabletop 11.

FIG. 19 shows a bowl 1 on the bottom of which a charcoal tray 6 is arranged. Through an opening in one of the sidewalls of the bowl 1 an electrically-operated heating element 17 is guided with its end connectable to a power source. At the opposing sidewalls of the bowl 1 adjoining to the sidewall through which the electrically-operated heating element 17 is guided with its end connectable to a power source the electrically- operated heating element 17 is fastened detachably.

FIG. 20 shows the components of a grill installation kit according to the invention depicted in FIG. 19 comprising a grillage 5 covering the bowl 1 when installed.

### LIST OF REFERENCE NUMERALS

1 bowl

2 ash trap

3a spacer (between the bottom of the bowl and the ash trap)

3b spacer (between the ash trap and the firing tray)

4 firing tray

5 grillage

6 charcoal tray

7 charcoal frame

8 rim of the bowl

9 spacer element

10 recess of a tabletop

11 tabletop

11a individual elements of a tabletop 11

12 grooves in the template bars

13 template bars

14 cover profiles

15 fasteners

16 table

17 electrically-operated heating element

18 screw connection

19 wing nut

20 grillage spacer

21 grooves in the grillage spacers

22 side panel

23 spit

24 connecting bridge

25 USB port

26 motor-driven spit attachment

27 grill plate

28 grill pan

29 slider

1. Grill installation kit for a table, comprising
a bowl (1) having openings in each sidewall and at the bottom,
an ash trap (2) which extends essentially in a plane and can be arranged on the bottom of the bowl (1) spaced by at least one spacer (3a) and essentially in parallel to the bottom of the bowl,
a firing tray (4) having openings, which firing tray (4) can be arranged on the ash trap (2) spaced by at least one spacer (3b) and essentially in parallel to the ash trap (2), and
a grillage (5).

2. The grill installation kit according to claim 1, characterized by a charcoal tray (6) and/or a charcoal frame (7) which can be arranged on the firing tray (4) at the side opposite the bottom of the bowl (1).

3. The grill installation kit according to claim 1, wherein the at least one spacer (3a) and/or the at least one spacer (3b) is arranged at the ash trap (2).

4. The grill installation kit according to claim 1, wherein the at least one spacer (3b) can be connected to the firing tray (4) in a force-fitting and/or positive-fitting way.

5. The grill installation kit according to claim 1, wherein the firing tray (4) and the bottom of the bowl (1) are connected to one another by a screw connection (18), by means of which the distance of the firing tray (4) to the bottom of the bowl (1) can be varied.

6. The grill installation kit according to claim 5, characterized by a wing nut (19) arranged at the bottom of the bowl (1), which wing nut (19) is disposed to vary the distance of the firing tray (4) to the bottom of the bowl (1) upon actuation.

7. The grill installation kit according to claim 1, wherein the bowl (1) has a rim (8) confining its open side, at the side of which rim (8) facing the bottom of the bowl (1) several spacer elements (9) are arranged which hold the bowl (1) at a distance to the tabletop (11) upon arrangement in a recess (10) of a tabletop (11).

8. The grill installation kit according to claim 1, characterized by mounting accessories comprising four template bars (13) having grooves (12), four cover profiles (14) and fasteners (15).

9. The grill installation kit according to claim 1, wherein the grill installation kit is arranged in a recess (10) of a tabletop (11) of a table (16).

10. The grill installation kit according to claim 1, characterized by an electrically-operated heating element (17) which with its end connectable to a power source can be guided through a sidewall of the bowl (1).
